(19) United States
(12) Patent Application Publication
(10) Pub. No.: US 2019/0044913 A1
(43) Pub. Date: Feb. 7, 2019

(54) NETWORK APPARATUS, METHOD OF PROCESSING PACKETS, AND STORAGE MEDIUM HAVING PROGRAM STORED THEREON

(71) Applicant: Hitachi, Ltd., Tokyo (JP)

(72) Inventors: Naoki TANIDA, Tokyo (JP); Nodoka MIMURA, Tokyo (JP); Yuji TSUSHIMA, Tokyo (JP); Daisuke MATSUBARA, Tokyo (JP); Katsufumi KON, Tokyo (JP); Tetsuya OOHASHI, Tokyo (JP); Hiroyuki MIKITA, Tokyo (JP)

(21) Appl. No.: 15/919,249

(22) Filed: Mar. 13, 2018

(30) Foreign Application Priority Data
Aug. 4, 2017 (JP) 2017-151552

(51) Int. Cl. H04L 29/06; H04L 12/26; H04L 12/851

(52) U.S. Cl. CPC H04L 63/0245; H04L 43/18; H04L 43/045; H04L 63/1408; H04L 47/2441

(57) ABSTRACT

To analyze communication information correctly and to extract task information, it is provided a network apparatus, which is configured to process packets, the network apparatus comprising: an arithmetic device; a storage device coupled to the arithmetic device; and an interface coupled to an apparatus, the apparatus being configured to transmit and receive packets. The arithmetic device being configured to execute processing in accordance with a predetermined procedure to implement: a reception processing module configured to receive a packet from the apparatus; and a vectorization module configured to convert a scalar value, which is a value of each byte of the received packet, into a vector value based on a predetermined vectorization algorithm.

### CLAIM OF PRIORITY

The present application claims priority from Japanese patent application JP 2017-151552 filed on Aug. 4, 2017, the content of which is hereby incorporated by reference into this application.

### BACKGROUND OF THE INVENTION

This invention relates to a network apparatus.

When security measures are implemented in an infrastructure control system, it is difficult to change programs of apparatus forming a network because operations in the control system may change. Therefore, it is required to take security measures by monitoring packets on the control network.

For this reason, hitherto, there have been implemented technologies for detecting suspicious communications and occurrences of hacking processes by monitoring the packets of the control network. However, when a cyberattack is performed using correct communication for the control system, the attack cannot be detected by those technologies. In order to prevent attacks that use correct communication, it is important to identify communication patterns related to tasks to detect a task that is abnormal for correct communication.

As the background art in this technical field, there is known WO 2016/20660 A1. In WO 2016/20660 A1, there is disclosed a method of detecting a cyber-threat to a computer system. The method is arranged to be performed by a processing apparatus. The method includes receiving input data associated with a first entity associated with the computer system, deriving metrics from the input data, the metrics representative of characteristics of the received input data, analyzing the metrics using one or more models, and determining, in accordance with the analyzed metrics and a model of normal behavior of the first entity, a cyber-threat risk parameter indicative of a likelihood of a cyber-threat. In WO 2016/20660 A1, there are also disclosed a computer readable medium, a computer program, and a threat detection system.

In the method described in WO 2016/20660 A1, a model of normal behavior and a cyber-threat risk are analyzed based on a plurality of measurement criteria including network packet data, but there is a problem in that when the meaning of the information defined by the format of the network packets (e.g., what data is written in each field) is unknown, information related to tasks cannot be extracted and analyzed from the network packet data.

The representative one of inventions disclosed in this application is outlined as follows. There is provided a network apparatus, which is configured to process packets, the network apparatus comprising: an arithmetic device; a storage device coupled to the arithmetic device; and an interface coupled to an apparatus, the apparatus being configured to transmit and receive packets, the arithmetic device being configured to execute processing in accordance with a predetermined procedure to implement: a reception processing module configured to receive a packet from the apparatus; and a vectorization module configured to convert a scalar value, which is a value of each byte of the received packet, into a vector value based on a predetermined vectorization algorithm.

According to representative aspects of this invention, communication information can be correctly analyzed and task information can be extracted. Problems, configurations, and effects other than those described above are made clear based on the following description of embodiments of this invention.

### BRIEF DESCRIPTION OF THE DRAWINGS

The present invention can be appreciated by the description which follows in conjunction with the following figures, wherein:

FIG. 1 is a diagram for illustrating an example of a configuration of a network system according to a first embodiment;

FIG. 2 is a block diagram for illustrating an example of a hardware configuration and a program configuration of an analysis apparatus according to the first embodiment;

FIG. 3 is a diagram for illustrating an example of a format of a mirror packet received by the analysis apparatus according to the first embodiment;

FIG. 4 is a block diagram for illustrating a relationship among function modules of the analysis apparatus and a transfer apparatus according to the first embodiment;

FIG. 5 is a diagram for illustrating an example of a data structure held by a communication state management module according to the first embodiment;

FIG. 6 is a diagram for showing an example of a data structure held by a learning result storage module according to the first embodiment;

FIG. 7 is a diagram for showing an example of a data structure held by a vectorization rule according to the first embodiment;

FIG. 8 is a flowchart for illustrating details of processing executed by a reception processing module according to the first embodiment;

FIG. 9 is a flowchart for illustrating details of processing executed by a grouping module according to the first embodiment;

FIG. 10 is a flowchart for illustrating details of processing executed by a vectorization module according to the first embodiment;

FIG. 11 is a flowchart for illustrating details of processing executed by an imaging module according to the first embodiment;

FIG. 12 is a diagram for illustrating an example of a screen output by the imaging module according to the first embodiment;

FIG. 13 is a flowchart for illustrating details of processing executed by a machine learning module according to the first embodiment;

FIG. 14 is a flowchart for illustrating details of processing executed by a monitoring module according to the first embodiment;

FIG. 15 is a diagram for illustrating an example of a configuration of a network system according to a second embodiment;

FIG. 16 is a block diagram for illustrating an example of a hardware configuration and a program configuration of a learning apparatus according to the second embodiment;

FIG. 17 is a block diagram for illustrating an example of a hardware configuration and a program configuration of a monitoring apparatus according to the second embodiment; and

FIG. 18 is a block diagram for illustrating a relationship among functional modules of the learning apparatus, the monitoring apparatus and a transfer apparatus according to the second embodiment.

### DETAILED DESCRIPTION OF THE PREFERRED EMBODIMENTS

Embodiments of this invention are described below with reference to the accompanying drawings. It should be noted that the embodiments described below are merely examples for implementing this invention and do not limit a technical scope of this invention. Components common across the drawings are denoted by the same reference symbols.

### First Embodiment

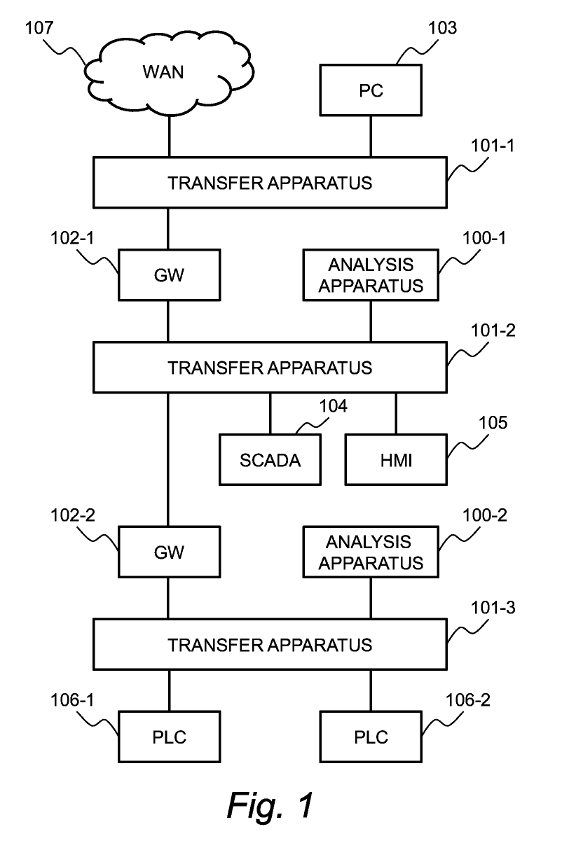

In a first embodiment of this invention, a basic example of this invention is described. FIG. 1 is a diagram for illustrating an example of a configuration of a network system in the first embodiment.

The network system in the first embodiment is a control system network constructed from one or more analysis apparatus 100, transfer apparatus 101, gateways 102, a computer 103, a supervisory control and data acquisition (SCADA) system 104, a human machine interface (HMI) 105, programmable logic controllers (PLCs) 106, and a wide-area network (WAN) 107. The number of apparatus constructing the control system network is not limited to the number illustrated in FIG. 1, and it is sufficient if one or more of each apparatus is included. In the following description, suffixes are omitted (e.g., transfer apparatus 101) when apparatus of the same type are collectively described, and suffixes are written (e.g., transfer apparatus 101-1) when apparatus of the same type are individually described.

The analysis apparatus 100, the gateways 102, the PC 103, the SCADA 104, the HMI 105, the PLCs 106, and the WAN 107 are coupled to each other via the transfer apparatus 101.

In the example illustrated in FIG. 1, the WAN 107 and the PC 103 are coupled to a transfer apparatus 101-1, a GW 102-1 is coupled to the transfer apparatus 101-1 and a transfer apparatus 101-2, and an analysis apparatus 100-1, the SCADA 104, and the HMI 105 are coupled to the transfer apparatus 101-2, a GW 102-2 is coupled to the transfer apparatus 101-2 and a transfer apparatus 101-3, and the analysis apparatus 100-1, a PLC 106-1, and a PLC 106-2 are coupled to the transfer apparatus 101-3.

The transfer apparatus 101 is, for example, an apparatus such as a switch or a router, and transfers packets transmitted from a coupled apparatus to another apparatus. The transfer apparatus 101 has a function of duplicating received packets to generate mirror packets. The transfer apparatus 101 transmits the generated mirror packets to the analysis apparatus 100. The gateway 102 is, for example, a server having a firewall function, a switch function, a router function, a packet relay function, and other functions. The gateway 102 also has a function of blocking transfer of the packets based on a set rule when transferring packets transmitted from a coupled apparatus to another apparatus. The PC 103 is, for example, a general office-use server, a workstation, or a personal computer.

The SCADA 104 is a computer configured to perform system management and process control in the control system. The HMI 105 is a computer configured to provide a function that allows a person to view SCADA information. The PLC 106 is a computer having a function for controlling industrial machines and the like in the control system. The WAN 107 is an external network.

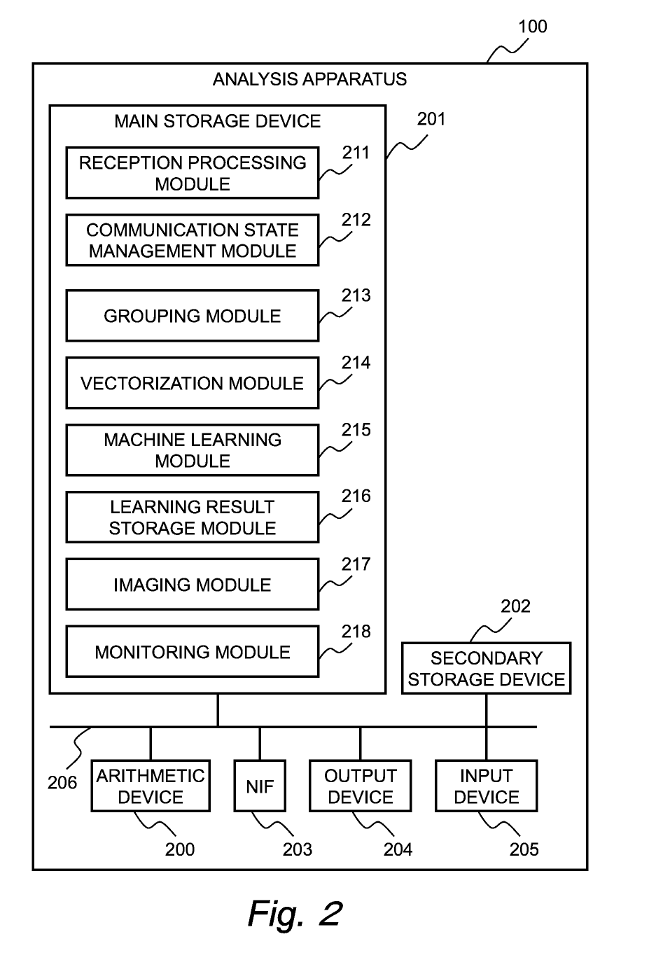

The analysis apparatus 100 analyzes the mirror packets received from the transfer apparatus 101 to extract a task in the control system. A “task” is an exchange of a series of data that has a meaning in the operation of the control system, for example, an “exchange of a series of data from the transmission of a control command to the end of the control by the command (e.g., reply to a control result)” or an “exchange of data for continuous alive monitoring for a specific device”. The analysis apparatus 100 monitors the mirror packets received from the transfer apparatus 101 to detect communication that is not related to tasks. The analysis apparatus 100 also provides an interface for visualizing information obtained from the mirror packets received from the transfer apparatus 101. The analysis apparatus 100 is arranged separately from the transfer apparatus 101, but the analysis apparatus 100 may also be incorporated in the transfer apparatus 101. One analysis apparatus 100 may be coupled to a plurality of transfer apparatus 101. As described later in a second embodiment of this invention, the analysis apparatus 100 may be divided into a plurality of apparatus. The analysis apparatus 100 is described in more detail below with reference to FIG. 2.

FIG. 2 is a block diagram for illustrating an example of a hardware configuration and a program configuration of the analysis apparatus 100 in the first embodiment.

The analysis apparatus 100 includes, as a hardware configuration, an arithmetic device 200, a main storage device 201, a secondary storage device 202, a network interface function (NIF) 203, an output device 204, and an input device 205. The arithmetic device 200, the main storage device 201, the secondary storage device 202, the NIF 203, the output device 204, and the input device 205 are coupled to one another via a system bus 206. Each component may be directly coupled to one another, or may be coupled to one another via a plurality of buses.

The arithmetic device 200 is, for example, a central processing unit (CPU) or a graphics processing unit (GPU), which is configured to execute programs stored in the main storage device 201. Each function of the analysis apparatus 100 is implemented by the arithmetic device 200 executing a program. In the following description, when processing is described by using a functional module as the subject of the sentence, this means that the arithmetic device 200 executes a program for implementing that functional module.

The main storage device 201 stores the programs to be executed by the arithmetic device 200 and the data required to execute the programs. The main storage device 201 includes a ROM, which is a non-volatile memory element, and a RAM, which is a volatile memory element. The ROM stores a fixed program (e.g., BIOS) and the like. The RAM is a high-speed and volatile memory element, for example, a dynamic random access memory (DRAM), and temporarily stores a program to be executed by the arithmetic device 200 and data to be used at the time of execution of the program. The main storage device 201 has a work area to be used by each program and a storage area, for example, a buffer. The programs stored in the main storage device 201 are described later.

The secondary storage device 202 includes a non-volatile mass storage device such as a hard disk drive (HDD) or a flash memory (SSD), and stores a program to be executed by the arithmetic device 200 and data. The programs and data stored in the main storage device 201 may be stored in the secondary storage device 202. In this case, the arithmetic device 200 reads the programs and the data from the secondary storage device 202 and loads the programs and data onto the main storage device 201.

The NIF 203 is an interface for controlling communication to/from other apparatus in accordance with a predetermined protocol. The analysis apparatus 100 in the first embodiment includes the NIF 203 for coupling to the transfer apparatus 101. The NIF 203 outputs mirror packets received from the transfer apparatus 101 to a reception processing module 211, which is described later.

The output device 204 is an interface for outputting processing results and the like of the analysis apparatus 100. For example, a display and a touch panel for displaying the processing results are conceivable as the output device 204. An NIF for transmitting the processing results to another apparatus can be mounted to the output device 204. The output device 204 may be implemented as an output function, and may be mounted in various methods.

The input device 205 is an input interface for designating control and parameters of the analysis apparatus 100. For example, the input device 205 is a keyboard, a mouse, or a touch panel. An NIF for receiving inputs from another apparatus may be mounted to the input device 205. The input device 205 may be implemented as an input function, and may be mounted in various methods.

Next, an outline of the programs stored in the main storage device 201 is described. The main storage device 201 in the first embodiment stores programs for implementing the reception processing module 211, a communication state management module 212, a grouping module 213, a vectorization module 214, a machine learning module 215, a learning result storage module 216, an imaging module 217, and a monitoring module 218. Programs other than those described above may also be stored in the main storage device 201. Details of the processing by each program are described later.

The reception processing module 211 duplicates the data of the mirror packets received from the transfer apparatus 101 to a memory and passes the data of the mirror packets to the grouping module 213.

The communication state management module 212 stores the data of the mirror packets grouped by the grouping module 213 and vectorized by the vectorization module 214 as a vector value sequence for each group.

The grouping module 213 classifies the mirror packet data into groups of packets that may have been generated by a series of tasks. The grouping module 213 has a buffer for temporarily storing packets. In the analyzing apparatus 100 in the first embodiment, the grouping module 213 classifies the packets received by the reception processing module 211 into groups, but the grouping module 213 may group the packets after the vectorization module 214 has converted the packets into vector values.

The vectorization module 214 vectorizes the packet data grouped by the grouping module 213. At the time when the packet data is received from the grouping module 213, the packet data is represented by a sequence of byte values, which are each a scalar value. Information not included in the data sequence itself, such as semantic information and time information in the protocol header of the packet, is added to the scalar value of each byte, the data of each byte is converted into a vector value, and the packet data is arranged as an array of vector values. This vectorization enables extraction of information that cannot be obtained by simply analyzing the packet data itself.

The machine learning module 215 learns communication related to tasks by machine learning to calculate a parameter for classifying packets by using the packet data grouped by the grouping module 213 and vectorized by the vectorization module 214.

The learning result storage module 216 holds the parameter for classifying the packet data learned by the machine learning module 215. The parameter held by the learning result storage module 216 is used by the monitoring module 218 to classify the packet data based on whether or not the packet data is communication related to tasks.

The imaging module 217 is a function for generating image data from the data of the mirror packets grouped by the grouping module 213 and vectorized by the vectorization module 214. This function enables the data being learned and data being monitored to be visualized, and packet trends and occurrence of security risks to be known.

The monitoring module 218 compares the learned normal task and the received mirror packet data to detect packets that are not related to tasks as being a security risk.

A vectorization rule 219 is stored in the secondary storage device 202 or the main storage device 201. The vectorization rule 219 holds rules for converting the scalar values into vector values by the vectorization module 214. The rules may be hard-coded at the time of design, or may be input from the input device 205.

A program to be executed by the arithmetic device 200 is provided to the analysis apparatus 100 via a removable medium (e.g., CD-ROM or flash memory) or via a network, and is stored into the secondary storage device 202, which is a non-transitory storage medium. Thus, it is desired that the analysis apparatus 100 include an interface for reading data from the removable medium.

The analysis apparatus 100 is a computer system constructed on one physical computer or a plurality of logical or physical computers, and may be executed by separate threads on the same computer or may be executed on a virtual computer constructed on a plurality of physical computer resources.

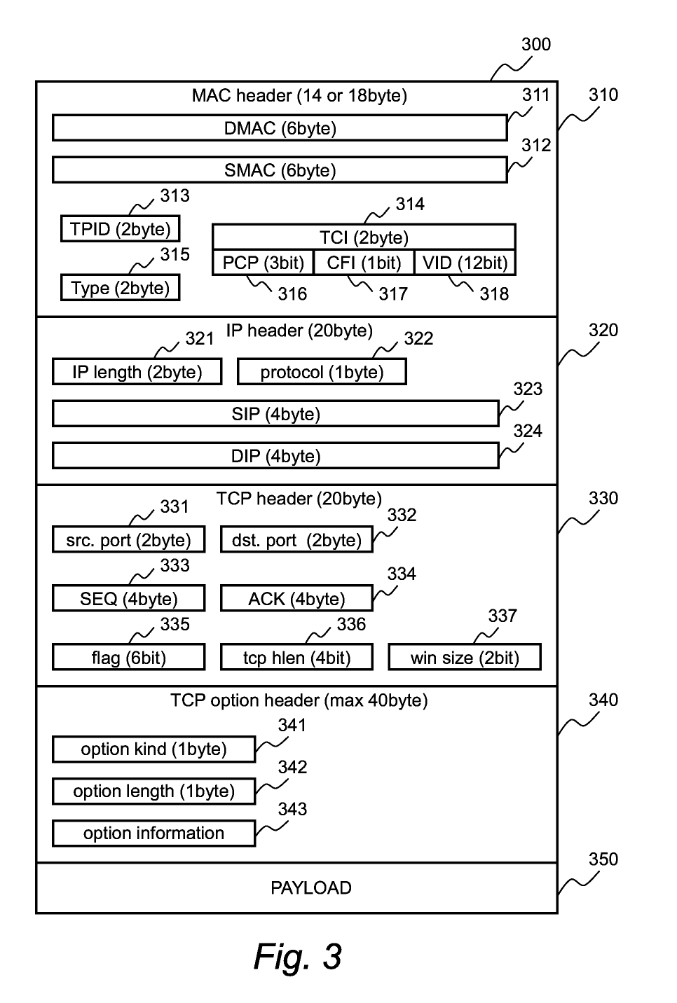

FIG. 3 is a diagram for illustrating an example of a format of a mirror packet received by the analysis apparatus 100 in the first embodiment.

The packet 300 includes a media access control (MAC) header 310, an Internet Protocol (IP) header 320, a transmission control protocol (TCP) header 330, a TCP option header 340, and a payload 360.

The MAC header 310 includes a DMAC 311, an SMAC 312, a tag protocol identifier (TPID) 313, tag control information (TCI) 314, and a type 315. The DMAC 311 indicates a destination MAC address. The SMAC 312 indicates a source MAC address. The TPID 313 indicates that the packet is a tagged frame, and indicates the type of tag. The TCI 314 indicates information on the tag. The type 315 indicates the type of MAC frame.

The TCI 314 includes a port control protocol (PCP) 316, a canonical format indicator (CFI) 317, and a virtual local-area network (VLAN) identifier (VID) 318. The PCP 316 indicates a priority. The CFI 317 indicates whether or not the MAC address is a regular form. The VID 318 indicates a VLAN ID. In the case of a network in which a VLAN is not used, the TPID 313 and the TCI 314 do not exist. In this case, the analysis apparatus 100 performs processing assuming that the VID is “0”.

The IP header 320 includes an IP length 321, a protocol 322, a SIP 323, and a DIP 324. The IP length 321 indicates the packet length excluding the MAC header 310. The protocol 322 indicates a protocol number. The SIP 323 indicates a source IP address. The DIP 324 indicates a destination IP address.

The TCP header 330 includes a src. port 331, a dst. port 332, a SEQ 333, an ACK 334, a flag 335, a tcp hlen 336, and a win_size 337. The src. port 331 indicates a source port number. The dst. port 332 indicates a destination port number. The SEQ 333 indicates a transmission sequence number. The ACK 334 indicates a reception sequence number. The flag 335 indicates a TCP flag number. The tcp hlen 336 indicates a TCP header length. The win_size 337 indicates an advertisement window size to be notified to a counterparty apparatus.

The TCP option header 340 includes zero or a plurality of options. For example, options such as an option kind 341, an option length 342, and option information 343 are included. The option kind 341 indicates an option type. The option length 342 indicates an option length. The option information 343 indicates information in accordance with the type of option.

For example, a maximum segment size (MSS) option is used to notify the counterparty apparatus of an MSS size capable of being received by the own apparatus when starting TCP communication. A selective acknowledgment (SACK) option is used to notify the counterparty apparatus that the own apparatus is compatible with the SACK option when starting TCP communication. The SACK option is further used to notify the counterparty apparatus of a data portion that was partially received when a packet is detected as having been discarded during communication. A time stamp option is used to notify the counterparty apparatus of the reception time by the own apparatus during communication. A window scale option is used to increase the maximum value of an advertisement window size that can be notified to the counterparty apparatus by notifying the counterparty apparatus of how many bits the value notified by the win_size 337 is to be shifted to the right. In this way, the TCP option header 340 is used to notify the counterpart apparatus of functions and information supported by the own apparatus when starting communication and during communication.

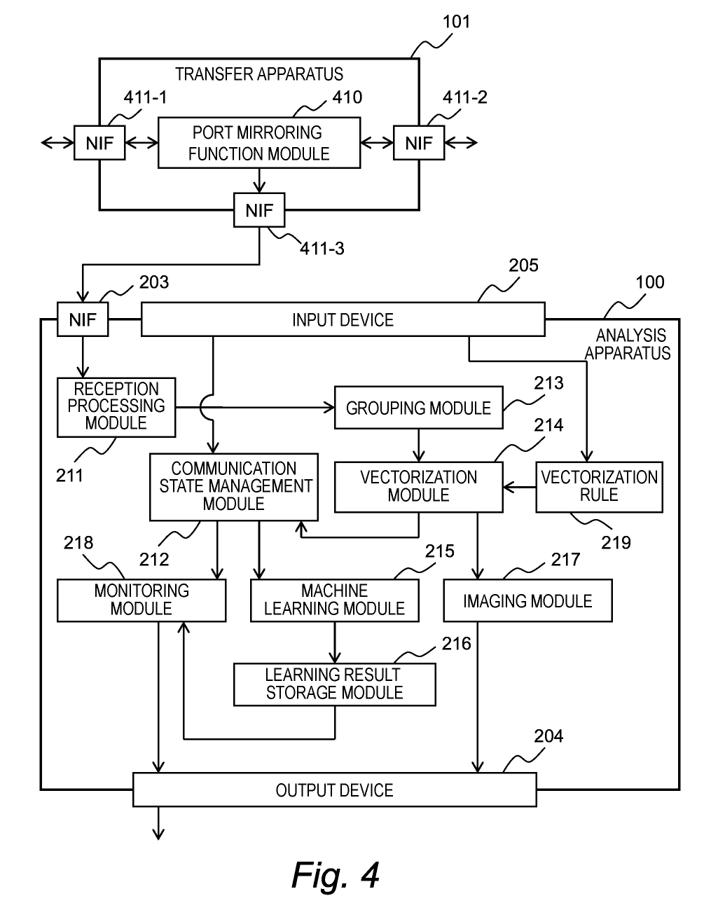

FIG. 4 is a block diagram for illustrating a relationship among the function modules of the analysis apparatus 100 and the transfer apparatus 101 in the first embodiment. The transfer apparatus 101 includes three or more NIFs 411-1, 411-2, 411-3, and also includes a port mirroring function module 410.

The port mirroring function module 410 transfers the packet received from the NIF 411-1 to the NIF 411-2, and transmits a mirror packet identical to the received packet from the NIF 411-3 to the analysis apparatus 100. The port mirroring function module 410 transfers the packet received from the NIF 411-2 to the NIF 411-1 and transmits a mirror packet identical to the received packet from the NIF 411-3 to the analysis apparatus 100.

The NIF 203 outputs the mirror packet received from the transfer apparatus 101 to the reception processing module 211.

The reception processing module 211 monitors input from the NIF 203, and when a packet is input, outputs the input packet to the grouping module 213.

The grouping module 213 classifies, based on a predetermined algorithm, the packet data received from the reception processing module 211 into a group possibly generated by a series of tasks. After the classification, the packet data is output to the vectorization module 214 in group units. The predetermined algorithm is described later.

The vectorization module 214 vectorizes the grouped packet data received from the grouping module 213 in accordance with the method described in the vectorization rule 219 to generate a vector value sequence. The vectorization module 214 outputs the vectorized data to the communication state management module 212 and the imaging module 217.

The communication state management module 212 holds the generated vector value sequence in accordance with the classified group. The data (vector value sequence) held by the communication state management module 212 is referred to by the machine learning module 215 and the monitoring module 218.

The machine learning module 215 receives the grouped vector value sequence from the communication state management module 212, learns communication related to tasks, and stores the learning result into the learning result storage module 216.

The learning result storage module 216 holds a parameter obtained as a learning result by the machine learning module 215. The parameter held by the learning result storage module 216 is used by the monitoring module 218 to classify communication related to tasks and communication that is not related to tasks.

The imaging module 217 converts the data (vector value sequence) of the mirror packets grouped by the grouping module 213 and vectorized by the vectorization module 214 into image data. When the vector value is not a three-dimensional vector, it is desired that the data be converted into a three-dimensional vector and then converted into red-green-blue (RGB) data.

The monitoring module 218 receives the grouped vector value sequence from the communication state management module 212, and refers to the parameter held by the learning result storage module 216 to determine whether or not the vector value sequence is communication related to tasks. When the vector value sequence is communication that is not related to tasks, the monitoring module 218 determines that there is a security risk in the packet, and outputs an abnormality to the output device 204.

The vectorization rule 219 holds rules for converting the byte values into vector values by the vectorization module 214. The rules may be hard-coded at the time of design, or may be input from the input device 205.

As described above, the above-mentioned function blocks are implemented by the arithmetic device 200 executing programs, but a part or all of the function blocks may be constructed from hardware (for example, a field-programmable gate array (FPGA)).

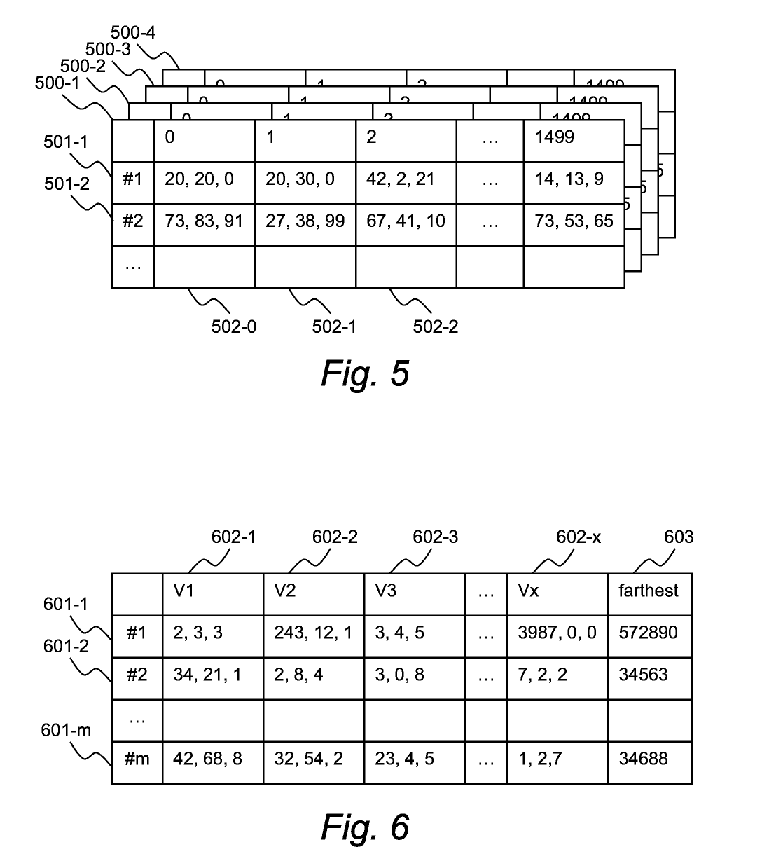

FIG. 5 is a diagram for illustrating an example of a data structure held by the communication state management module 212.

The communication state management module 212 holds the data vectorized by the vectorization module 214 in accordance with the groups classified by the grouping module 213. In the example shown in FIG. 5, four tables 500-1 to 500-4 hold the data of four groups. Each of rows 501-1 and 501-2 corresponds to the data of a mirror packet. Columns 502-0, 502-1, 502-2, . . . of each table correspond to the byte values of the original packet data. In FIG. 5, each byte value has been converted into a three-dimensional vector value and held. In the example shown in FIG. 5, a vector value sequence is held in a table format for each group, but the vector value sequence can be held in another format.

FIG. 6 is a diagram for showing an example of a data structure held by the learning result storage module 216.

The learning result storage module 216 holds the parameter learned by the machine learning module 215 in order to classify the packet data based on whether or not the packet data is communication related to tasks. In the example shown in FIG. 6, each of rows 601-1, 601-2, . . . 601-m represents a classification of the packet data by the vectorization module 214, and is classified into m types. Each of V1 602-1 to Vx 602-x represents the “center of gravity” of each vector value in each classification. The packet data held in the communication state management module 212 shown in FIG. 5 has a packet length of 1,500 bytes. Therefore, x in FIG. 6 is 1,500. A column “farthest 603” indicates the “distance” farthest from the “center of gravity” in each classification. The “center of gravity” and “distance” are described later. In the example described with reference to FIG. 6, the center of gravity and the distance are held in a table format, but the center of gravity and the distance may be held in another format.

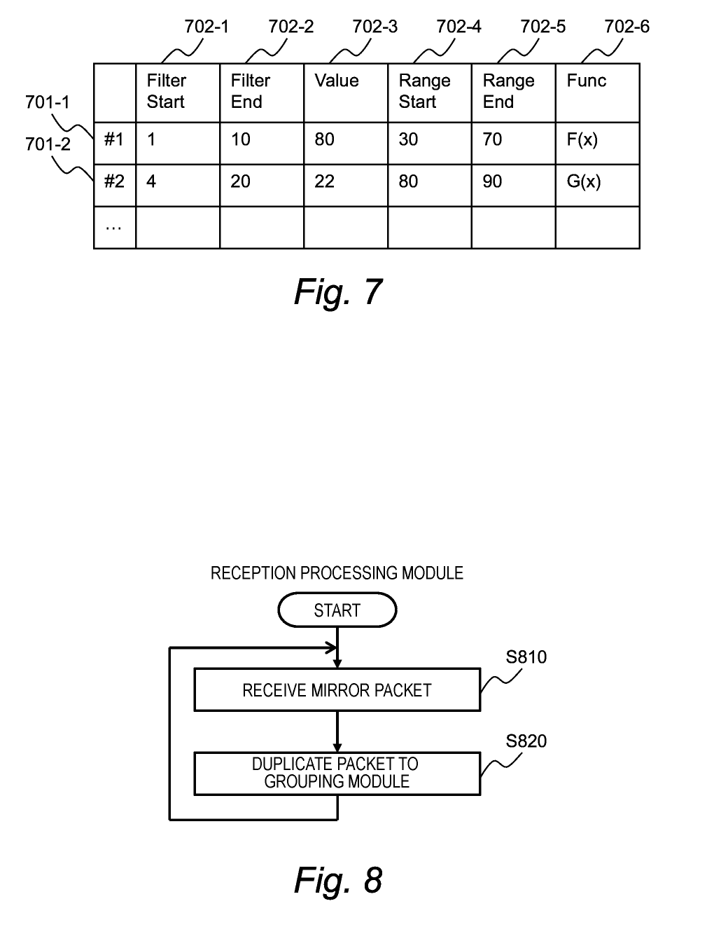

FIG. 7 is a diagram for showing an example of a data structure held by the vectorization rule 219.

The vectorization rule 219 holds rules for the vectorization module 214 to convert each byte value of the packet data into a vector value sequence.

In each row of the vectorization rule 219, a rule for converting the byte values of the packet data into vector values is defined, and a plurality of rules can be held. As many rules as the number of defined rules are applied in order, that is, a rule #2 701-2 is applied after a rule #1 701-1 is applied. The vectorization rule 219 may be defined such that subsequent rules are not applied after application of the first rule to be applied.

Each rule of the vectorization rule 219 includes a filter condition start position 702-1, a filter condition end position 702-2, a filter condition value 702-3, an applicable range start position 702-4, an applicable range end position 702-5, and a vectorization function 702-6.

Each rule of the vectorization rule 219 is defined such that when the numerical value between the number of bytes of the filter condition start position 702-1 and the number of bytes of the filter condition end position 702-2 from the head of the packet data matches the filter condition value 702-3, the vectorization function 702-6 is applied to the numerical value between the number of bytes of the applicable range start position 702-4 and the number of bytes of the applicable range end position 702-5 from the head of the packet data.

More specifically, in the rule #1 701-1, when the numerical value of the byte defined in the filter condition start position 702-1 and the filter condition end position 702-2 is the filter condition value 702-3, namely, when the value of the first to tenth bytes is 80, a vectorization function F(x) is applied to the values of the 30th to the 70th bytes defined in the applicable range start position 702-4 and the applicable range end position 702-5. In this case, when F(x) is defined as F(x)=(x, 0, x̂2) with the original byte value x as an argument, the amount of conversion of the numerical value of a specific byte is increased, which enables a vector to be generated having a dimension in which the numerical value of that byte is increased. This allows, for example, when a specific protocol is defined in the filter condition, information indicating that the filter condition is a specific protocol to be embedded by increasing a specific vector component.

Further, in the rule #2 701-2, when the numerical value of the byte defined in the filter condition start position 702-1 and the filter condition end position 702-2 is the filter condition value 702-3, namely, when the value of the fourth to twentieth bytes is 22, a vectorization function G(x) is applied to the values of the 80th to the 90th bytes defined in the applicable range start position 702-4 and the applicable range end position 702-5. In this case, when G(x) is defined as G(x)=(0, 0, 0), a vector having a meaningless dimension can be generated for the numerical value of a specific byte. This allows, for example, information to be embedded indicating that, for a certain condition, the numerical value of a specific byte does not have a meaning.

In this way, in the vectorization module 214, a vector to which a useful meaning has been added to analyze a packet from the value of each byte of the packet is generated by using a rule defined in the vectorization rule 219.

In the example described above, the vectorization function may or may not include the original byte value. Further, based on the byte value of a certain position (filter condition range), the byte value of another position (filter applicable range) can be controlled. In the example described above, a three-dimensional vector is generated so as to correspond to each byte value of the packet, but a vector having another dimension can be generated.

In the example described above, the vectorization rule is defined by a vectorization function, but the scalar values may be converted to vector values by using a rule defined in another format, for example, a predefined correspondence table, without using a function.

Next, the processing by each module is described with reference to flowcharts. FIG. 8 is a flowchart for illustrating the details of the processing executed by the reception processing module 211.

After the analyzing apparatus 100 is activated, the reception processing module 211 waits for reception of a mirror packet from the transfer apparatus 101 (Step S810), and duplicates the received mirror packet data to the grouping module (Step S820). Then, the reception processing module 211 repeats the processing of Step 5810 and Step 5820.

The reception processing module 211 may also start this processing at times other than the activation of the analysis apparatus 100.

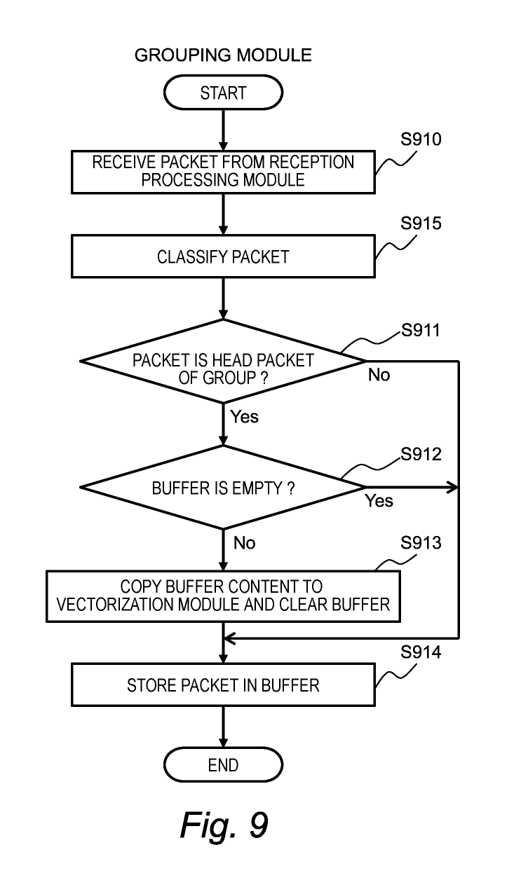

FIG. 9 is a flowchart for illustrating the details of the processing executed by the grouping module 213.

When the grouping module 213 receives mirror packet data from the reception processing module 211 (Step S910), the grouping module 213 classifies the received mirror packet data by using a predetermined algorithm (Step S915). Some examples of the predetermined algorithm to be used in Step S915 are now described.

As a first example, the grouping module 213 may classify the received mirror packet data based on whether or not four values including the value of the service. port, which is the smaller port number between the src. port 331 and the dst. port 332, the value of the protocol 322, the value of the SIP 323, and the value of the DIP 324 are identical. In this example, packets that are communication by the same application between the same terminals can be classified.

As a second example, the received mirror packet data may be classified based on whether or not two values including the packet length and the protocol 322 are identical. In this example, packets containing the same instruction can be classified.

Next, the grouping module 213 determines whether or not the classified mirror packet data is the head packet of the group by using a predetermined algorithm (Step S911). Several examples of the predetermined algorithm to be used in Step S911 are now described.

As a first example, when packets having the same classification are received after an elapse of a predetermined delta time, those packets are determined to be a head group packet. In this example, when sequential communication relating to a series of tasks is performed, the packets of the series of tasks can be grouped.

As a second example, when a SYN flag is set in the flag 335, it is determined that the received packet is the head group packet. In this example, the packets of a series of tasks can be grouped by a protocol in which communication is disconnected for each series of tasks.

As a third example, when the value of a specific field of the payload 350 is set as a grouping index (so-called sentinel value), the received packet is determined to be the head group packet when the sentinel value is a specific value. This example is effective when the definition of the payload and a part of the semantic information are known.

As a result, when the received packet is not the group head packet, the grouping module 213 stores the received packet into the buffer (Step S914).

Meanwhile, when the received packet is the group head packet, the grouping module 213 determines whether or not the buffer is empty (Step S912). When it is determined that the buffer is empty, the grouping module 213 stores the received packet into the buffer (Step S914).

Meanwhile, when it is determined that the buffer is not empty, the grouping module 213 duplicates the packets stored in the buffer to the vectorization module 214, and clears the buffer (Step S913). The grouping module 213 then stores the received packet into the buffer (Step S914).

After storing the received packet into the buffer, the grouping module 213 ends this processing and waits to receive the next packet.

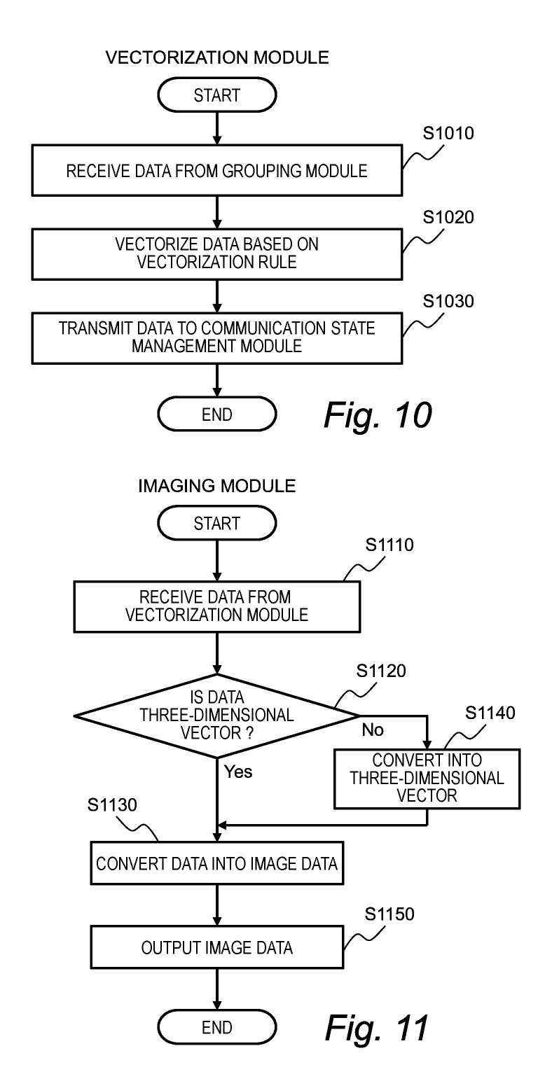

FIG. 10 is a flowchart for illustrating the details of the processing executed by the vectorization module 214.

When the vectorization module 214 receives data from the grouping module 213 (Step S1010), the vectorization module 214 vectorizes the data in accordance with a rule described in the vectorization rule 219 (Step S1020). Then, the vectorization module 214 transmits the vectorized data to the communication state management module 212, and ends the processing (Step S1030).

FIG. 11 is a flowchart for illustrating the details of the processing executed by the imaging module 217.

When the imaging module 217 receives data from the vectorization module 214 (Step S1110), the imaging module 217 determines whether or not the received data is a three-dimensional vector sequence (Step S1120).

When it is determined in Step S1120 that the received data is a three-dimensional vector sequence, the imaging module 217 advances the processing to Step S1130. Meanwhile, when it is determined that the received data is not a three-dimensional vector sequence, the imaging module 217 converts each vector value into a three-dimensional vector based on a predetermined algorithm (Step S1140), and the processing then advances to Step S1130.

For example, when n>3 for an n-dimensional vector, the predetermined algorithm classifies each dimension by a remainder (n mod 3) obtained by dividing n by 3, and converts an n-dimensional vector to a three-dimensional vector by adding the values of the classified dimensions. For example, a five-dimensional vector (11, 22, 33, 44, 55) is converted into a three-dimensional vector (55, 77, 33).

Meanwhile, when it is determined in Step S1120 that the received data is a three-dimensional vector sequence, the imaging module 217 converts the received data into bitmap (BMP) format image data by using each dimensional value of the three-dimensional vector as an RGB value of the image (Step S1130). In place of RGB, another color space may be used. In place of the BMP format, the received data may be converted into image data of another format, such as a graphics interchange format (GIF) or a portable network graphics (PNG) format.

The imaging module 217 outputs the image data to the output device 204 (Step S1150), and then ends the processing.

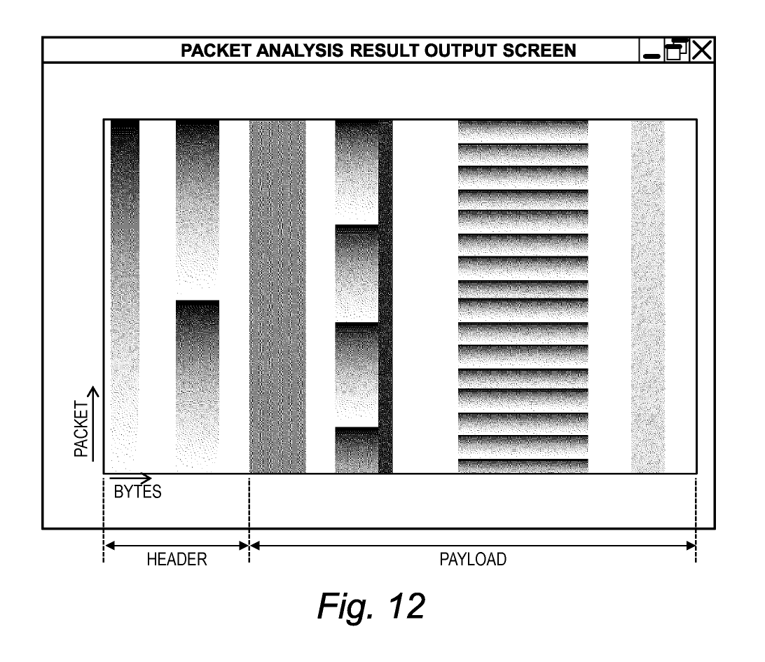

FIG. 12 is a diagram for illustrating an example of a screen output by the imaging module 217.

In the screen illustrated in FIG. 12, vector values classified into one group are displayed, with the horizontal axis representing the number of bytes from the head of the packet. Each byte of the packet is displayed based on color depth, and one packet of information is displayed for one row (one vertical dot). In other words, the vertical axis represents packets. The information on one byte may be displayed as a predetermined number of dots (e.g., four dots), and information having a predetermined number of bytes may be displayed as one dot.

In the screen illustrated in FIG. 12, packets having the same length are classified. However, when packets having different lengths are to be classified, it is desired that the packet lengths be padded with zeros to equalize the packet lengths.

In this way, through displaying of the packets, it can be seen based on the change in color in the vertical direction whether or not a given portion is the same value for each packet or different for each packet.

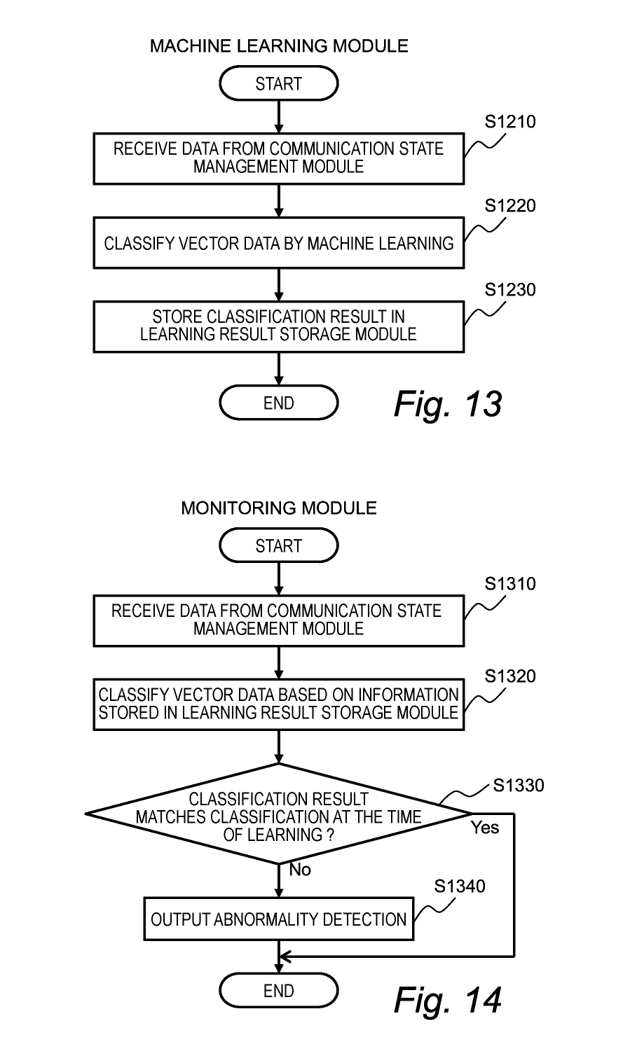

FIG. 13 is a flowchart for illustrating the details of the processing executed by the machine learning module 215.

When the machine learning module 215 receives data from the communication state management module 212 (Step S1210), the machine learning module 215 classifies the vector data by machine learning (Step S1220).

As an example of the machine learning, the following method can be employed. First, the distance of each grouped vector value sequence held in the communication state management module 212 is obtained. Then, Euclidean distances are obtained in order from the beginning of the vector value sequence to create a scalar value sequence, and the distances are calculated by, when the number of scalar value sequence is n, obtaining the n-th root of the sum of the squares of each scalar value. After the distance of each grouped vector value has been obtained, each vector value is divided into a plurality of clusters by a method generally known as hierarchical cluster analysis. The number m of clusters to be generated can be input from the input device 205 at the start of machine learning, hard-coded at the time of designing, or automatically generated during the machine learning process. The generated m clusters are communication classified as being tasks, and hence it is desired that, in the system to be analyzed by the analysis apparatus 100, the value of m be set close to a number that is grasped by an operator of the system as being the types of tasks.

After the division into clusters, the center of gravity of each cluster is obtained. The center of gravity is obtained as a vector value by determining the geometric center of gravity of all the vector values of the vector value sequence included in each cluster.

The distance between each vector value and the center of gravity of each cluster is obtained, and the farthest distance in each cluster is obtained.

The machine learning module 215 stores the center of gravity of each cluster and the farthest distance in each cluster as a learning result into the learning result storage module 216, and then ends the processing (Step S1230).

There is described above an example of machine learning by hierarchical cluster analysis, but other machine learning methods may also be used as long as the method enables learning capable of determining whether or not a trend is different between newly received packets and previous packets.

FIG. 14 is a flowchart for illustrating the details of the processing executed by the monitoring module 218.

When the monitoring module 218 receives data from the communication state management module 212 (Step S1310), the monitoring module 218 classifies the vectorized data by using information stored in the learning result storage module 216 (Step S1320). The distances between the m centers of gravity stored in the learning result storage module 216 and the vectorized data are obtained and classified in the closest cluster.

The monitoring module 218 determines whether or not the classification result of the data vectorized by using the information stored in the learning result storage module 216 matches the classification at the time of learning (Step S1330). When the distance to the center of gravity of the classified cluster is farther than the farthest 603, which is the farthest distance, the data received by the monitoring module 218 is not to be classified in the cluster, and the monitoring module 218 determines that the received data does not match the classification at the time of learning.

When it is determined in Step S1330 that there is a match, the monitoring module 218 ends the processing. Meanwhile, when it is determined that there is not a match, this means that the data received by the monitoring module 218 is not classified in any cluster, and hence the monitoring module 218 determines that communication that is not a normal task has occurred, outputs to the output device 204 a message that an abnormality has been detected, and ends the processing (Step S1340). Examples of the mode of outputting this message to the output device 204 include outputting data for displaying a screen notifying that an abnormality has occurred, issuing an alarm sound, and outputting a notification to the HMI 105 to activate a rotating warning lamp.

In the analysis apparatus 100 in the first embodiment, the processing is executed by using a mirror packet transmitted from the transfer apparatus 101 including the port mirroring function module 410. However, the same processing may be executed by a network tap branching and extracting a network signal, and using the extracted packet.

In the first embodiment, TCP is described an example of the communication protocol, but the first embodiment can also be applied to protocols other than TCP. For example, this invention can be applied as long as the communication protocol is a protocol in which, like user datagram protocol (UDP), data is divided into packets and transmitted and received with a certain length as an upper limit.

In addition, when packets having different lengths are to be classified into one cluster, it is desired that the subsequent data be padded with zeros to equalize the packet lengths.

In the first embodiment, even when the semantic information on the payload data in the communication protocol is unknown, it is possible to analyze the communication to extract the task information, to thereby detect security risks such as a cyberattack. In particular, security risks can be detected even when it is not desired for delays to occur at the nodes due to the installation of security software in the network. In addition, operation verification is required in order to install security software, but communication that is not related to normal tasks can be detected without requiring operation verification.

This invention can also be applied to a case in which the format (e.g., semantic information on payload data) in the communication protocol is known. In that case, it is possible to reduce the number of program design steps for interpreting the semantic information on the payload data in the communication protocol in order to detect security risks.

### Second Embodiment

In the first embodiment, learning of communication related to normal tasks and monitoring of whether or not the communication is included in a normal task are implemented in the same analysis apparatus 100. In the second embodiment, there is described an example in which learning and monitoring are implemented in different apparatus.

The second embodiment is described focusing on the differences from the first embodiment. In the second embodiment, like parts and like processes to those in the first embodiment are denoted by like reference symbols, and a description thereof is omitted.

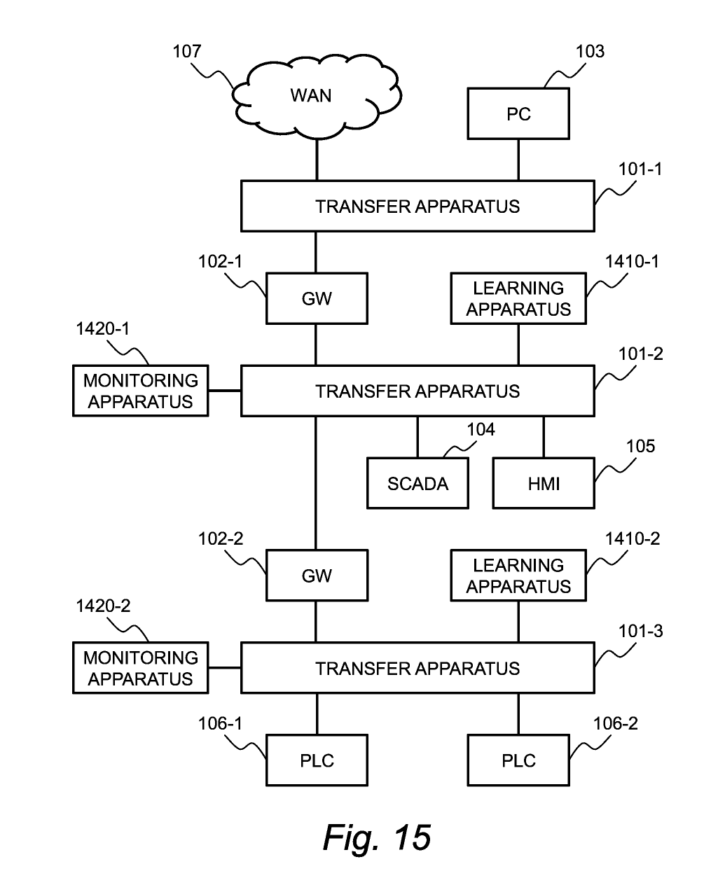

FIG. 15 is a diagram for illustrating an example of a configuration of a network system in the second embodiment.

The network system in the second embodiment is a control system network constructed from one or more transfer apparatus 101, learning apparatus 1410, monitoring apparatus 1420, the gateways 102, the computer 103, the SCADA 104, the HMI 105, the PLCs 106, and the WAN 107. The number of apparatus constructing the control system network is not limited to the number illustrated in FIG. 15, and it is sufficient if one or more of each apparatus is included. In the following description, suffixes are omitted (e.g., learning apparatus 1410) when apparatus of the same type are collectively described, and suffixes are written (e.g., learning apparatus 1410-1) when apparatus of the same type are individually described.

The learning apparatus 1410, the monitoring apparatus 1420, the gateways 102, the PC 103, the SCADA 104, the HMI 105, the PLCs 106, and the WAN 107 are coupled to one another via the transfer apparatus 101.

In the example illustrated in FIG. 15, in place of the analysis apparatus 100-1 in the first embodiment, the learning apparatus 1410-1 and a monitoring apparatus 1420-1 are coupled to the transfer apparatus 101-2, and in place of the analysis apparatus 100-2 in the first embodiment, a learning apparatus 1410-2 and a monitoring apparatus 1420-2 are coupled to the transfer apparatus 101-3.

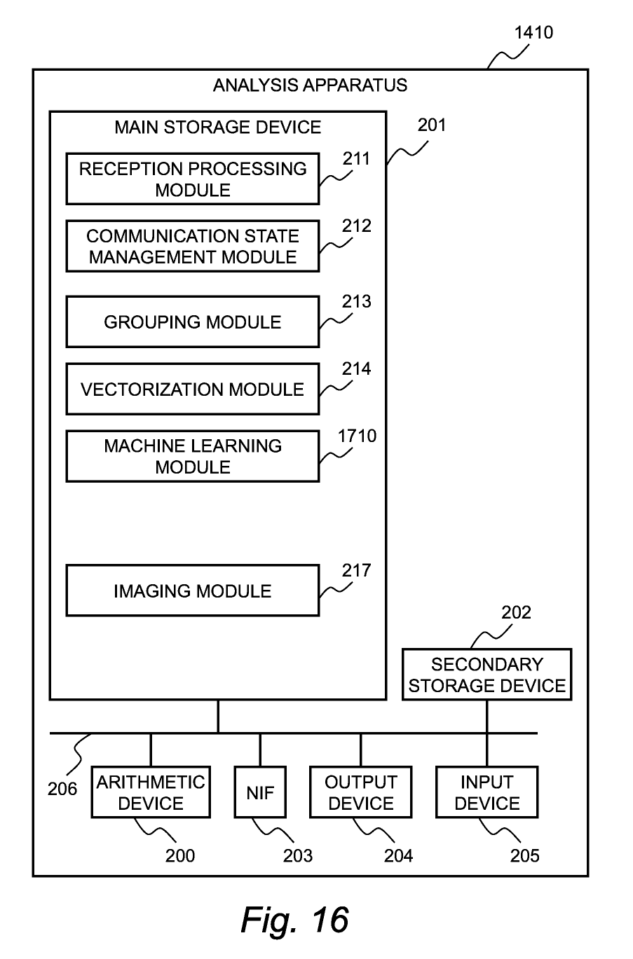

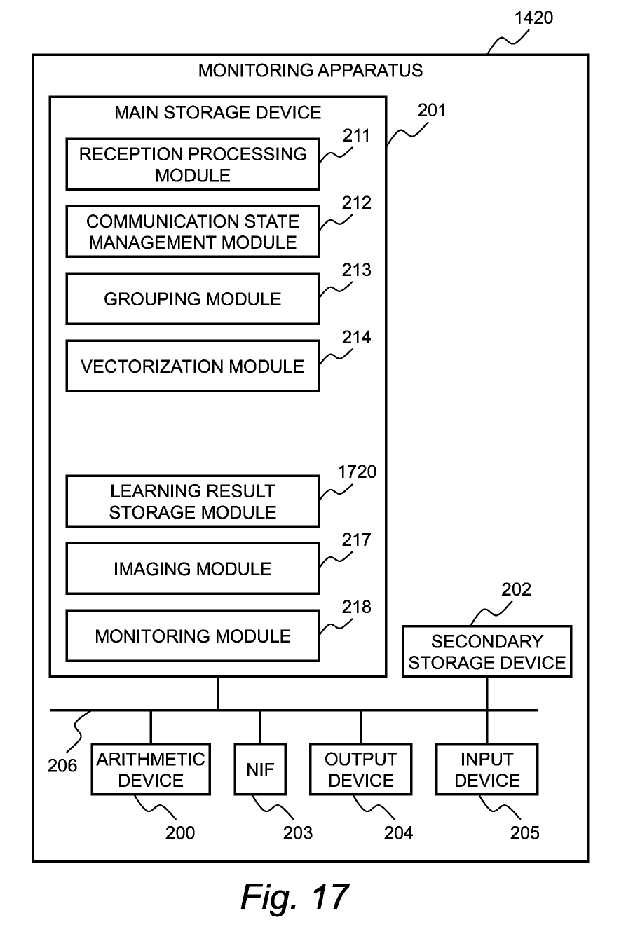

The learning apparatus 1410 analyzes the mirror packets received from the transfer apparatus 101 to extract the task in the control system. The monitoring apparatus 1420 monitors the mirror packets received from the transfer apparatus 101 to detect communication that is not related to tasks. The learning apparatus 1410 and the monitoring apparatus 1420 provide an interface for visualizing information obtained from the mirror packet received from the transfer apparatus 101. Details of the learning apparatus 1410 are described later with reference to FIG. 16, and details of the monitoring apparatus 1420 are described later with reference to FIG. 17.

FIG. 16 is a block diagram for illustrating an example of a hardware configuration and a program configuration of the learning apparatus 1410 in the second embodiment.

The hardware configuration of the learning apparatus 1410 is the same as that of the analysis apparatus 100 in the first embodiment, and hence a description thereof is omitted here.

The main storage device 201 of the learning apparatus 1410 stores programs for implementing the reception processing module 211, the communication state management module 212, the grouping module 213, the vectorization module 214, a machine learning module 1710, and the imaging module 217. The reception processing module 211, the communication state management module 212, the grouping module 213, the vectorization module 214, and the imaging module 217 are the same as in the first embodiment, and hence a description thereof is omitted here.

The vectorization rule 219 is stored in the secondary storage device 202 or the main storage device 201. The vectorization rule 219 holds rules for converting the scalar values into vector values by the vectorization module 214. The vectorization rule 219 is the same as in the first embodiment, and hence a description thereof is omitted here.

The machine learning module 1710 of the learning apparatus 1410 learns communication related to tasks by machine learning by using the packet data grouped by the grouping module 213 and vectorized by the vectorization module 214 to calculate a parameter for classifying the packets, and outputs the calculated parameter to the output device 204. The learning apparatus 1410 may also include a learning result storage module 1720. More specifically, it is sufficient for any one of the learning apparatus 1410 and the monitoring apparatus 1420 to include the learning result storage module 1720.

FIG. 17 is a block diagram for illustrating an example of the hardware configuration and the program configuration of the monitoring apparatus 1420 in the second embodiment.

The hardware configuration of the monitoring apparatus 1420 is the same as that of the analysis apparatus 100 in the first embodiment, and hence a description thereof is omitted here.

The main storage device 201 of the monitoring apparatus 1420 stores programs for implementing the reception processing module 211, the communication state management module 212, the grouping module 213, the vectorization module 214, the learning result storage module 1720, the imaging module 217, and the monitoring module 218. The reception processing module 211, the communication state management module 212, the grouping module 213, the vectorization module 214, the learning result storage module 1720, the imaging module 217, and the monitoring module 218 are the same as in the first embodiment, and hence a description thereof is omitted here.

The vectorization rule 219 is stored in the secondary storage device 202 or the main storage device 201. The vectorization rule 219 holds rules for converting the scalar values into vector values by the vectorization module 214. The vectorization rule 219 is the same as in the first embodiment, and hence a description thereof is omitted here.

In other words, the monitoring apparatus 1420 is obtained by removing the machine learning module 215 from the analysis apparatus 100 in the first embodiment.

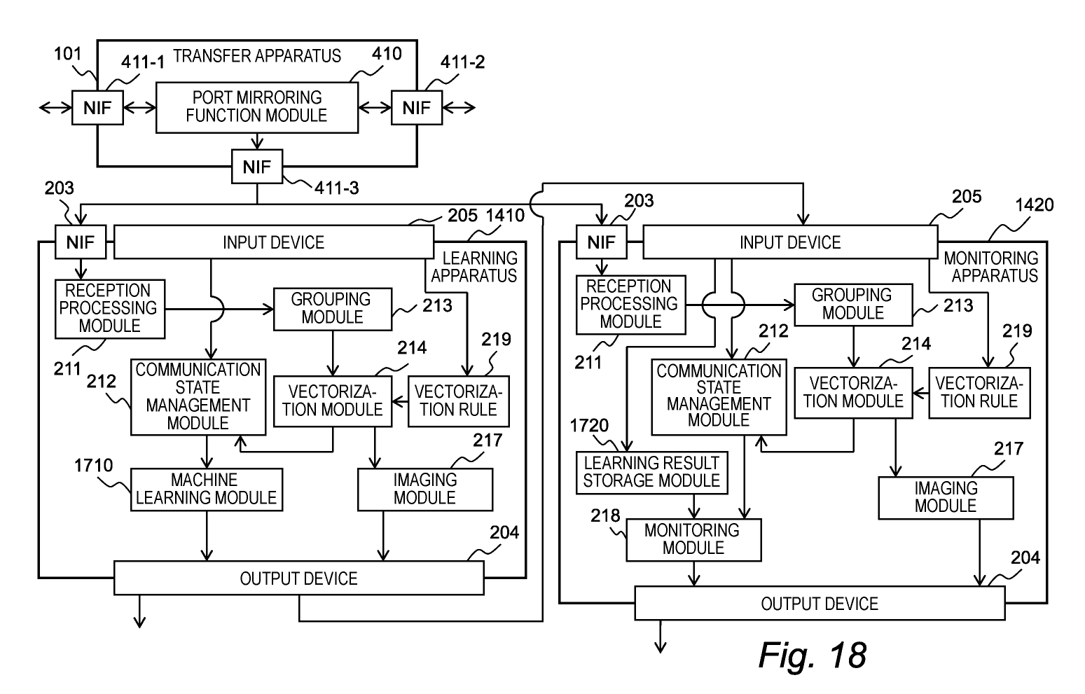

FIG. 18 is a block diagram for illustrating a relationship among the functional modules of the learning apparatus 1410, the monitoring apparatus 1420, and the transfer apparatus 101 in the second embodiment.

In the second embodiment, the machine learning module 1710, which involves a heavy processing load, and the monitoring module 218, which requires real-time processing, are implemented in separate apparatus, and hence the processing capability of the entire system can be increased, and security risks can thus be detected for a large amount of communication.

A part or all of the reception processing module 211, the communication state management module 212, the grouping module 213, the vectorization module 214, the imaging module 217, and the vectorization rule 219 may be shared between the learning apparatus 1410 and the monitoring apparatus 1420, and implemented on any one of the learning apparatus 1410 and the monitoring apparatus 1420.

### Third Embodiment

In the first embodiment, learning of communication related to normal tasks and monitoring of whether or not communication is included in a normal task are implemented in the same analysis apparatus 100. In a third embodiment of this invention, there is described an example of an apparatus that does not have a learning function or a monitoring function, and in which the data of vectorized packets is displayed in an image.

The third embodiment is described focusing on the differences from the first embodiment. In the third embodiment, like parts and like processes to those in the first embodiment are denoted by like reference symbols, and a description thereof is omitted.

The analysis apparatus 100 in the third embodiment includes, as a hardware configuration, the arithmetic device 200, the main storage device 201, the secondary storage device 202, the NIF 203, the output device 204, and the input device 205. The arithmetic device 200, the main storage device 201, the secondary storage device 202, the NIF 203, the output device 204, and the input device 205 are coupled to one another via the system bus 206. Each component may be directly coupled to one another, or may be coupled to one another via a plurality of buses.

The main storage device 201 in the third embodiment stores programs for implementing the reception processing module 211, the communication state management module 212, the grouping module 213, the vectorization module 214, and the imaging module 217. Programs other than those given above may also be stored in the main storage device 201. The details of the processing performed by each of the programs are the same as those in the first embodiment described above.

The vectorization rule 219 is stored in the secondary storage device 202 or the main storage device 201. The vectorization rule 219 holds rules for converting the scalar values into vector values by the vectorization module 214. The vectorization rule 219 is the same as in the first embodiment, and hence a description thereof is omitted here.

As described above, in the embodiments of this invention, the vectorization module 214 converts scalar values, which are the value of each byte of a received packet, into vector values based on a predetermined vectorization algorithm. Therefore, even when the meaning indicated by the data of each field of the network packets is unknown, the communication information can be correctly analyzed, and task information can be extracted.

The machine learning module 215 learns the data of the packet converted into vector values based on a predetermined learning algorithm to generate a parameter for determining that the packet is normal. The monitoring module 218 determines whether or not the packet converted into the vector values is normal by using the parameter generated by the machine learning module 215, and hence packets that are not related to normal tasks can detected, enabling security risks to be detected.

The grouping module 213 classifies received packets based on a predetermined grouping algorithm, and hence even when the meaning indicated by the data of each field of the network packet is unknown, the packets can be classified in accordance with the type of task. Further, packets of various behaviors can be classified so that a trend is easy to see and an abnormality can be easily detected.

The grouping module 213 classifies packets by using a SYN packet as a guide. Therefore, because the SYN packet is used in order to establish a new session in the TCP protocol, the packets can be easily classified into a series of tasks for a task in which a session is restarted for each task unit.

The grouping module 213 classifies packets based on an interval of the time stamps of the packets, and hence when the difference in time at which the transfer of similar packets is large, it can be determined that there has been a break in the task, which enables the series of tasks to be accurately determined based on the time difference.

The grouping module 213 classifies packets based on the value of a predetermined field, and hence when the value of a specific field is known for a specific task, the task can be accurately classified.

When the value of a first field of the received packet satisfies a predetermined condition, the vectorization module 214 can apply a predetermined rule (e.g., a vectorization function) corresponding to the condition to convert scalar values into vector values. Therefore, a plurality of vectorization functions can be switched based on the value of the specific field, enabling packets to be accurately classified.

When the value of the first field (e.g., header field) satisfies a predetermined condition, the vectorization module 214 applies a predetermined rule corresponding to the condition to convert the scalar value of a second field (e.g., payload field) into a vector value, and hence appropriate information can be added when the value of a given field indicates the meaning of another field. For example, the header field defines the position and meaning of the payload, and hence information on the payload can be added using header information.

The imaging module 217 generates display data for displaying the data converted into a vector value as an image, and hence the data can be displayed so that a person can easily see the trend of the packets transferred within the network system and an abnormality can be easily detected. Further, security risks can be easily detected.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A network apparatus, which is configured to process packets, the network apparatus comprising:
an arithmetic device;
a storage device coupled to the arithmetic device; and
an interface coupled to an apparatus, the apparatus being configured to transmit and receive packets,
the arithmetic device being configured to execute processing in accordance with a predetermined procedure to implement:
a reception processing module configured to receive a packet from the apparatus; and
a vectorization module configured to convert a scalar value, which is a value of each byte of the received packet, into a vector value based on a predetermined vectorization algorithm.

2. The network apparatus according to claim 1, further comprising a learning module configured to learn, based on a predetermined learning algorithm, data of the packet converted into vector values to generate a parameter for determining that the packet is normal.

3. The network apparatus according to claim 2, further comprising a monitoring module configured to determine whether the packet converted into the vector values is normal by using the parameter generated by the learning module.

4. The network apparatus according to claim 1, further comprising:
a grouping module configured to classify the received packet into a group based on a predetermined grouping algorithm; and
a state management module configured to store data of the packet converted into the vector values in accordance with the group obtained by the classification.

5. The network apparatus according to claim 4, wherein the grouping module is configured to classify the packet by using a SYN packet as a guide.

6. The network apparatus according to claim 4, wherein the grouping module is configured to classify the packet based on a time stamp interval of the packet.

7. The network apparatus according to claim 4, wherein the grouping module is configured to classify the packet based on a value of a predetermined field.

8. The network apparatus according to claim 1, wherein the vectorization module is configured to convert, in a case where a value of a first field of the received packet satisfies a predetermined condition, the scalar values into vector values by applying a predetermined rule corresponding to the predetermined condition.

9. The network apparatus according to claim 8, wherein the vectorization module is configured to convert, in a case where the value of the first field satisfies the predetermined condition, a scalar value of a second field different from the first field into a vector value by applying a predetermined rule corresponding to the predetermined condition.

10. The network apparatus according to claim 9, wherein the first field is included in a packet header and the second field is included in a payload.

11. The network apparatus according to claim 1, further comprising an imaging module configured to generate display data for displaying, as an image, data converted into vector values by the vectorization module.

12. A method of processing packets by a network apparatus,
the network apparatus including an arithmetic device configured to execute processing based on a predetermined procedure, a storage device coupled to the arithmetic device, and an interface coupled to an apparatus, the apparatus being configured to transmit and receive packets, the method comprising steps of:
receiving, by the arithmetic device, a packet from the apparatus; and
converting, by the arithmetic device, a scalar value, which is a value of each byte of the received packet, into a vector value based on a predetermined vectorization algorithm.

13. The method according to claim 12, further comprising steps of:
learning, based on a predetermined learning algorithm, data of the packet converted into vector values to generate a parameter for determining that the packet is normal; and
determining whether the packet converted into the vector values is normal by using the generated parameter.

14. The method according to claim 12, further comprising a step of generating display data for displaying data converted into vector values as an image.

15. A non-transitory machine-readable storage medium, containing at least one sequence of instructions for processing packets in a network apparatus,
the network apparatus including an arithmetic device configured to execute processing based on a predetermined procedure, a storage device coupled to the arithmetic device, and an interface coupled to an apparatus, the apparatus being configured to transmit and receive packets,
the program causing the arithmetic device to execute the procedures of:
the instructions that, when executed, causes the network apparatus to:
receiving a packet from the apparatus; and
converting a scalar value, which is a value of each byte of the received packet, into a vector value based on a predetermined vectorization algorithm.
